(19) United States
(12) Patent Application Publication
(10) Pub. No.: US 2010/0325080 A1
(43) Pub. Date: Dec. 23, 2010

(54) PATTERN MATCHING METHOD AND PROGRAM

(76) Inventor: Kiyohisa Ichino, Tokyo (JP)

Correspondence Address: Mr. Jackson Chen, 6535 N. STATE HWY 161, IRVING, TX, 75039, US

(21) Appl. No.: 12/526,358

(22) PCT Filed: Oct. 11, 2007
(86) PCT No.: PCT/JP2007/069814

§ 371 Date: Aug. 7, 2009

(30) Foreign Application Priority Data
Feb. 20, 2007 (JP) 2007-039209

(51) Int. Cl. G06N 5/02

(52) U.S. Cl. 706/48

(57) ABSTRACT

Columns are rearranged for every column unit so that the values of transition destinations of neighboring columns become closest to each other in accordance with a state transition table that has a current state arranged in a column direction and an input symbol arranged in a row direction and that shows the next state of transition destinations based on the current state and the input symbol, state names are changed to arrange the current state of each column in ascending order in the column rearranged state transition table, and a bit map indicative of changing points of values of column transition destinations and a transition destination table into which continuous same transition destinations are integrated are created for every row in the column rearranged state transition table.

### TECHNICAL FIELD

The present invention relates to a pattern matching method and program which judges whether or not a specific pattern is present in input data.

### BACKGROUND ART

Pattern matching for determining whether or not a specific pattern exists in input data is an elemental technology in the field of information processing, and its applications are wide-ranging. For example, these applications include text search in a word processor, DNA analysis in biotechnology, detection of a computer virus lurking in email, and so forth.

As one of means for implementing pattern matching, there is a method using a finite automaton (also known as a finite state machine). A finite automaton for pattern matching is created from a pattern or a set of patterns. As an example, an NFA (Non-deterministic Finite Automaton) and a DFA (Deterministic Finite Automaton) that accept three types of patterns “AB*C”, “A[B|C]”, and “CAB” will be described.

A regular expression is included in these patterns. The regular expression is a method of expressing patterns concisely.

“B*38 included in the first pattern “AB*C” represents a sequence of 0 or more “B”s. Thus, the first pattern matches text “AC”, “ABC”, and “ABBC”, . . . . Also, “[B|C]” included in the second pattern “A[B|C]” represents B or C. Thus, the second pattern matches text “AB” and “AC”.

FIG. 1 is a view showing one example of a conventional NFA that accepts three types of patterns “AB*C”, “A[B|C]”, and “CAB”. Also, FIG. 2 is a view showing one example of a conventional DFA that accepts three types of patterns “AB*C”, “A[B|C]”, and “CAB”. The difference between the NFA and the DFA will be described later.

A finite automaton for pattern matching starts from an initial state, and makes a transition to the next state through a branch corresponding to an input character. When a state (shown by double circles in FIGS. 1 and 2) corresponding to the last character of a pattern is reached, it is considered that the pattern is detected.

The above operation is repeatedly performed for all the characters from the beginning to the end of a text.

There are two expression types of finite automaton: NFA and DFA.

The DFA is a finite automaton where once the current state and an input are determined, the next state is uniquely determined, as indicated by the word “deterministic”.

Meanwhile, the NFA is a finite automaton where the next state is not uniquely determined. For example, when putting a focus on the NFA as shown in FIG. 1 that is in state 0, there are three states: state 0, state 4, and state 5 as transition destinations corresponding to an input character ‘A’.

In a case where the NFA is operated on a sequential processing computer, when there exists a plurality of transition destinations from any given state, this state is put on a stack, and then one of the plurality of transition destinations is selected to make a state transition. Then, the NFA is tracked until there is no state transition or until the end of the text is reached. Afterwards, one of the states is extracted from the stack, a return is made to that state, and a transition destination different from the previous one is selected and a state transition is made. The above operation is repeated until the stack becomes empty.

In the case where the NFA is operated on a sequential processing computer as described above, the behavior of turning back to a past state and restarting a state transition, that is, backtracking, is generated. Due to the effect of backtracking, the search speed based on the NFA is lower than that based on the DFA.

Meanwhile, the number of states included in the DFA tends to be greater than that of the DFA. Therefore, it is easy for the capacity of a memory for storing the DFA to become greater than that of the NFA. Although most applications that place emphasis on the speed of pattern matching employ not the NFA but the DFA, there are not a few cases in which challenges related to the required capacity of a memory are raised.

Generally, in a memory on a computer, the DFA is stored in the form of a state transition table.

FIG. 3 is a view showing one example of a state transition table stored in a memory on a computer.

The state transition table 10 shown in FIG. 3 is created from the DFA of FIG. 2, and corresponds to the DFA on one-on-one basis. The state transition table is a table in which a transition destination corresponding to a current state and an input symbol are listed. The number of elements in the state transition table is equal to a multiplication of the number of types of input symbols and the number of states.

In addition, a technique of reducing the total number of states of a finite state machine by division or synthesis is taken into account (for example, see Japanese Laid-Open Patent Publication No. 2002-297681).

In the field of pattern matching, it is not uncommon that if the number of patterns is large or if each pattern is complicated and long, the number of states of the DFA reaches several tens of thousands. With this, it is needless to say that the state transition table becomes enormous and a large amount of memory is consumed to store the state transition table.

Therefore, it is preferable to reduce the amount of information of the state transition table and decrease the amount of a memory for storing the state transition table in some way. However, the method of state transition must not be changed due to a reduction of the amount of information.

A decrease in size without causing the information to deteriorate is referred to as variable compression. As a way to realize variable compression, many well-known algorithms and implementations exist (LZ method, a block sorting method, Huffman coding, arithmetic coding, etc.)

It is possible to compress the state transition table by use of the well-known variable compression algorithm and store the state transition table in a memory after compression to reduce the amount of memory consumption. However, when the state transition table is compressed by use of the well-known variable compression algorithm, the following problem related to the speed of state transition occurs.

In the case of state transition using the compressed state transition table, it is necessary to find and extend a transition destination corresponding to a current state and an input among compressed data. In the well-known variable compression algorithm, data before compression is divided into blocks of a certain size and compressed in block units. That is, there is a problem in which data is extendable only in block units. The size of one transition destination in the state transition table is only a few bytes. Hence, the entire blocks have to be extended in order to obtain only a few bytes of information, so that unnecessary processing occurs and state transition becomes slow. Also, as the compression rate is lowered, the size of the blocks cannot be extremely small.

Also, in the technique disclosed in Japanese Laid-Open Patent Publication No. 2002-297681, an equivalent partial finite state automaton is substituted by one state transition and divided, so that reduction of amount of information of a state transition of the finite state automaton having no equivalent partial finite state automaton is not disclosed.

### DISCLOSURE

### Technical Problem

To solve the foregoing problems, it is an object of the present invention to provide a pattern matching method and program which can reduce the amount of information of a state transition table without increasing the calculation amount greatly upon a state transition.

### TECHNICAL SOLUTION

To achieve the above object, the present invention provides a pattern matching method using a finite automaton, including: rearranging columns for every column unit so that the values of transition destinations of neighboring columns become the closest to each other in accordance with a state transition table that has a current state arranged in a column direction and an input symbol arranged in a row direction and that shows the next state of transition destinations based on the current state and the input symbol; changing state names to arrange the current state of each column in ascending order in the column rearranged state transition table; and creating out, for every row in the column rearranged state transition table, a bit map indicative of changing points of values of column transition destinations and a transition destination table into which continuous same transition destinations are integrated.

As described above, in the present invention, the amount of information of a state transition table can be reduced without increasing the calculation amount greatly upon a state transition because columns are rearranged for every column unit so that the values of transition destinations of neighboring columns become closest to each other in accordance with a state transition table that has a current state arranged in a column direction and an input symbol arranged in a row direction and which shows a next state of transition destinations based on the current state and the input symbol, state names are changed to arrange the current state of each column in ascending order in the column rearranged state transition table, and a bit map indicative of changing points of values of column transition destinations and a transition destination table into which continuous same transition destinations are integrated are created for every row in the column rearranged state transition table.

### DESCRIPTION OF DRAWINGS

FIG. 1 is a view showing one example of a conventional NFA that accepts three types of patterns “AB*C”, “A[B|C]”, and “CAB”.

FIG. 2 is a view showing one example of a conventional DFA that accepts three types of patterns “AB*C”, “A[B|C]”, and “CAB”.

FIG. 3 is a view showing one example of a state transition table stored in a memory on a computer.

FIG. 4 is a view showing the state transition table after the state transition table shown in FIG. 3 is rearranged.

FIG. 5 is a flowchart for explaining the order of reducing the amount of information of the state transition table shown in FIG. 3.

FIG. 6 is a flowchart for explaining details of the process of step 100 shown in FIG. 5.

FIG. 7 is a view showing the content of REPLACE( ) after step 100 shown in FIG. 5 is executed.

FIG. 8 is a view showing one example of the state transition table after state names are changed.

FIG. 9 is a view showing one example of a bit map and a transition destination table made out in step 102 shown in FIG. 5.

FIG. 10 is a view showing one example of a label table made out from the bit map shown in FIG. 9.

FIG. 11 is a flowchart for explaining the sequence of obtaining a next state (=transition destination) when a current state and an input symbol are given.

FIG. 12 is a view schematically showing a method for determining a reference label from a current state “s”.

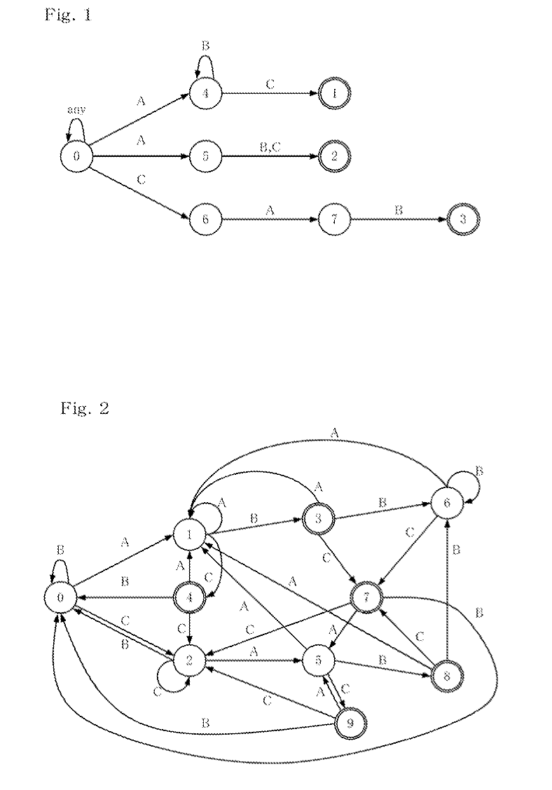

### BEST MODE FOR CARRYING OUT THE INVENTION

Hereinafter, an exemplary embodiment of the present invention will be described with reference to the accompanying drawings.

In the present invention, in a state transition diagram or state transition table for pattern matching, the amount of information of the state transition table is reduced by making use of the characteristic that, if an input is identical, there occur many transitions from multiple states to the same state.

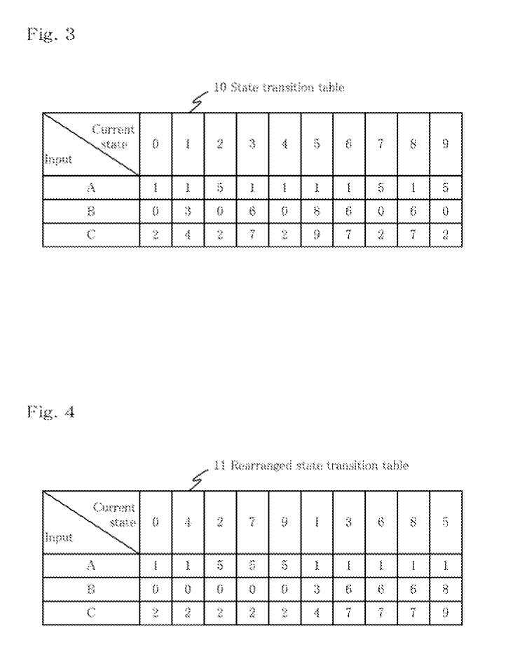

By use of an example of state transition table 10 shown in FIG. 3, this characteristic is made apparent. State transition table 10 shown in FIG. 3 is the one that was used in the description of the background art.

Regarding state transition table 10 shown in FIG. 3, if columns are rearranged so that the values of transition destinations of neighboring columns become closest to each other, this characteristic becomes remarkable.

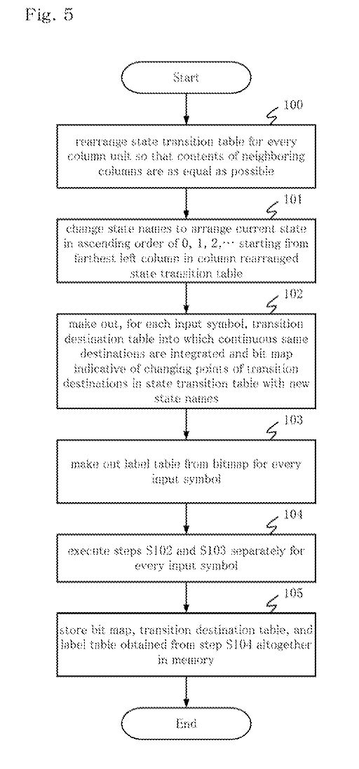

FIG. 4 is a view showing the state transition table after state transition table 10 shown in FIG. 3 is rearranged.

As shown in FIG. 4, rearranged state transition table 11 has many sequences of the same values (transition destinations) in a horizontal direction. The order of reducing the amount of information of the state transition table 10 based on this characteristic will be described.

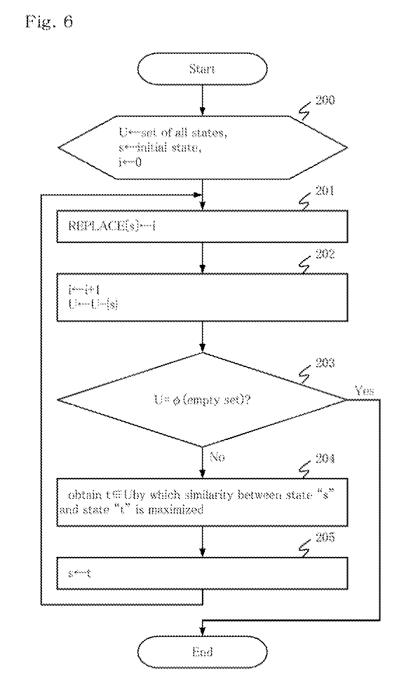

FIG. 5 is a flowchart for explaining the order of reducing the amount of information of state transition table 10 shown in FIG. 3.

First, columns are rearranged for every column unit so that the values of transition destinations of neighboring columns of state transition table 10 become closest to each other in step 100. State transition table 10 takes a form in which a current state is arranged in a column direction and an input symbol is arranged in a row direction. In the case of using a state transition table with reversed rows and columns, the state transition table is transposed (rotated at 90 degrees), or the words of ‘rows’ and ‘columns’ in a text are reversely read. The main purpose of this step is to create a table showing the correspondence relationship between the columns of the state transition table 10 and the columns of the rearranged state transition table 11. This table is referred to as REPLACE(•).

When a current state of any column of state transition table 10 is designated by “s”, REPLACE(s) shows the position of the column corresponding to “s” in the rearranged state transition table 11. The positions of the columns are numbered as 0, 1, 2, . . . , in order starting from the left side of rearranged state transition table 11.

For example, when a column corresponding to current state “4” of state transition table 10 shown in FIG. 3 is moved to the second column from the left side of rearranged state transition table 11, REPLACE(4)=1.

REPLACE(•) is a temporary array used in step 100 and step 101 to be described later, and is eventually not used in the memory.

Here, a state transition is represented by a two-dimensional array g(s,a). g(s,a) is a transition destination (=next state) when an input “a” is given when a current state is “s”.

Also, similarity between two columns is defined as an index of rearrangement. The similarity between a state “s” and a state “t” is calculated by (Formula 1).

$$similarity = {\sum }_{a ∈ \sum } δ ( g ( s , a ) - g ( t , a ) ) \\ δ ( x ) = \{ \begin{matrix}1 & ( x = 0 ) \\ 0 & ( x \neq 0 )\end{matrix} \qquad [ Formula 1 ]$$

The greater the value of similarity, the closer are the contents of the columns corresponding to those two states.

FIG. 6 is a flowchart for explaining details of the process of step 100 shown in FIG. 5.

In step 200, in state transition table 10, a set of all states is substituted into U and an initial state is substituted into s, and a column position “i” is initialized.

In step 201, the column position “i” of a transition destination of a state “s” is recorded in REPLACE(s), and then in step 202, the column position “i” is incremented, and the state “s” is removed from U. Afterwards, it is judged whether or not U is an empty set.

If U is an empty set, the process of step 100 is finished.

On the other hand, if U is not an empty set, one tεU, by which similarity between state “s” and state 1″ is maximized, is obtained. This similarity is calculated according to the above-stated (Formula 1).

Afterwards, in step S205, t is substituted into s, and the routine returns to step 201.

As is apparent from the flowchart of FIG. 6, REPLACE (initial state)=0. That is, a column corresponding to an initial state is moved to the farthest left column of rearranged state transition table 11.

If one example of state transition table 10 shown in FIG. 3 is rearranged according to the order of the above steps, rearranged state transition table 11 shown in FIG. 4 can be obtained.

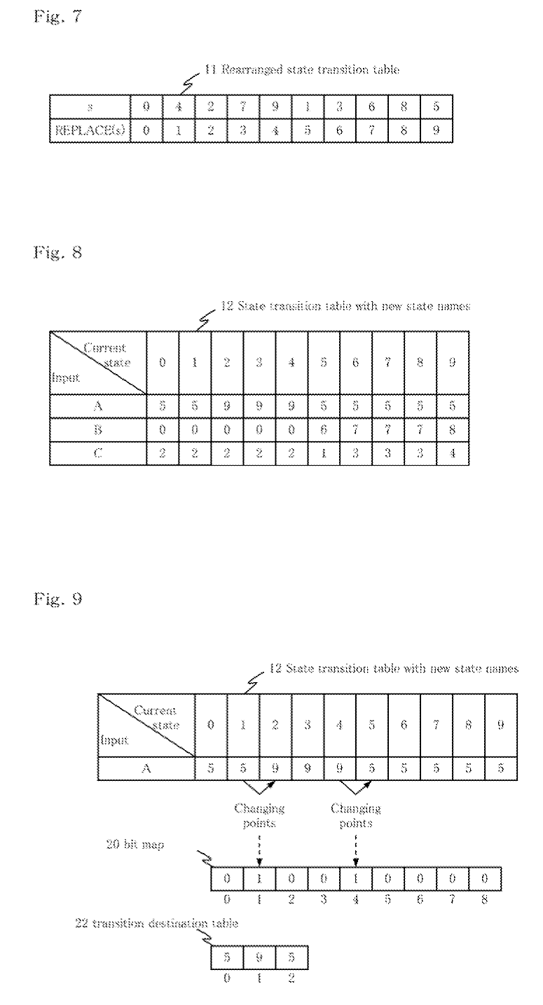

FIG. 7 is a view showing the contents of REPLACE(•) after step 100 shown in FIG. 5 is executed.

As shown in FIG. 7, state “s” and REPLACE(s) correspond to each other.

Afterwards, in step 101, state names are changed to arrange the current state in ascending order of 0, 1, 2, . . . , starting from the farthest left column in rearranged state transition table 11.

FIG. 8 is a view showing one example of the state transition table after state names are changed.

As shown in FIG. 8, in state transition table 12 with changed state names, when some current state “s” is arranged in an (x+1)-th column from the left, the new state name of the state “s” is X. Since the column position of a transition destination of state “s” is REPLACE(s), the new state name of the state “s” is equal to REPLACE(s).

If state transition table 12 with new state names is represented by a two-dimensional array g′(s,a), the relations of g′(REPLACE(s),a)=g(s,a) for ∀seε set of all states and ∀aεΣ are established. In addition, Σ is a set of all input symbols (characters in the case of text search). For example, Σ={A, B, C} or the like.

Also, since REPLACE (initial state)=0, the new state name of the initial state becomes 0. New state names of the other states are natural numbers.

Afterwards, in step 102, a transition destination table into which continuous same destinations are integrated and a bit map indicative of changing points of the transition destinations are created for each input symbol in state transition table 12 with new state names. The input symbol involved is a(aεΣ).

FIG. 9 is a view showing one example of a bit map and a transition destination table created in step 102 shown in FIG. 5. Here, bit map 20 corresponding to input symbol “A” of state transition table 12 with new state names shown in FIG. 8 is taken as an example.

Bit map 20 shown in FIG. 9 is a one-dimensional array of (number of states−1) bit width. If bit map 20 is represented by BITMAP(x)(0≦x<number of states−1), BITMAP(x)=0 when g′(x,a) and g′(x+1,a) are equal and BITMAP(x)=1 when they are not equal.

Also, transition destination table 22 shown in FIG. 9 is an array in which continuous same values are removed from g′(x,a)(0≦∀x<number of states) and only unique values are left, and transition destination table 22 corresponding to an input symbol “A” of state transition table 12 with new state names shown in FIG. 8 is taken as an example.

As shown in FIG. 9, since information of continuous same transition destinations are removed, it can be seen that the amount of information about the input symbol “A” of the state transition table decreases.

Therefore, in step 103, label table 21 is made out from bit map 20 for every input symbol.

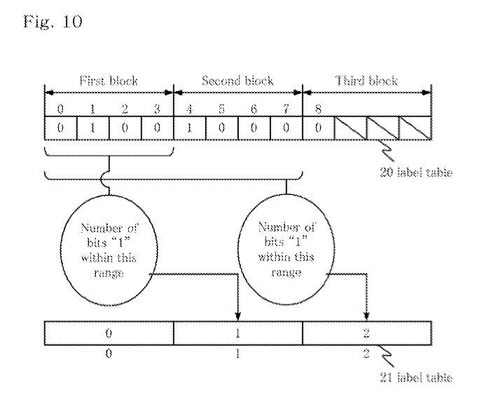

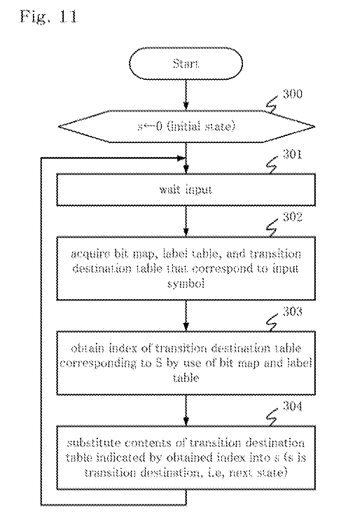

FIG. 10 is a view showing one example of a label table created from the bit map shown in FIG. 9.

Label table 21 shown in FIG. 10 is used as auxiliary information for speeding up state transition. A method of using label table 21 will be described later.

As shown in FIG. 10, bit map 20 is divided into blocks having a predetermined fixed length, and every block is given a label. Blocks and labels correspond to each other on a one on one basis. The value of a label is the number of bits of 1 among all the bits further to the left than the block corresponding to the label. The size of each block is B bits. In FIG. 4, B=4.

The value of a label can be obtained by use of (Formula 2):

$$LABEL ( n ) = \{ \begin{matrix}0 & ( n = 0 ) \\ {\sum }_{t = 0}^{nB - 1} BITMAP ( t ) & ( n \neq 0 )\end{matrix} \qquad [ Formula 2 ]$$

wherein the value of a label corresponding to the (x+1)-th block from the left side of bit map 20 is designated by LABEL (X). LABEL(0)=0. LABEL(X)(0≦X≦(number of states−2+B÷2)÷B (any digits after the decimal point are ignored)) is called label table 21.

Afterwards, in step 104, step 102 and step 103 are performed respectively for every input symbol. As a result, bit map 20, label table 21, and transition destination table 22 are created for each input symbol.

Afterwards, every bit map 20, label table 21, and transition destination table 22 obtained in step 104 are stored in a memory in step 105.

So far, the method of reducing the amount of information when state transition table 10 is given has been described.

Next, a method of making a state transition by using bit map 20, label table 21, and transition destination table 22 will be described.

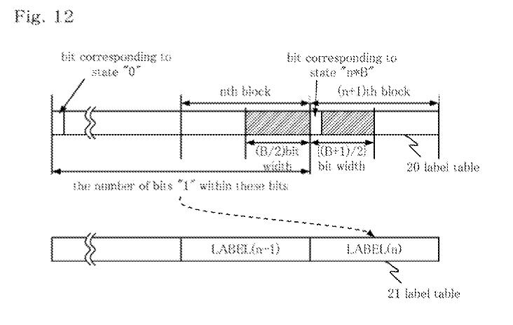

FIG. 11 is a flowchart for explaining the sequence of obtaining a next state (=transition destination) when a current state and an input symbol are given. s is a current state.

First, in step 300, s is initialized to an initial state, i.e., 0.

After initialization, an input is waited in step 301, and bit map 20, label table 21, and transition destination table 22 that correspond to an input symbol are acquired from the memory.

Then, in step 303, an index of transition destination table 22 corresponding to current state “s” is obtained by using bit map 20 and label table 21.

Here, in order to provide an explanation according to the order, first, a method of obtaining an index of transition destination table 22 will be described with reference only to bit map 20 without using label table 21.

The index of transition destination table 22 corresponding to current state “s” is given by a simple calculation formula (Formula 3):

$$index ( s ) = \{ \begin{matrix}0 & ( s = 0 ) \\ {\sum }_{t = 0}^{s - 1} BITMAP ( t ) & ( s \neq 0 )\end{matrix} \qquad [ Formula 3 ]$$

However, (Formula 3) has the following problem.

(Formula 3) is used to count the number of bits “1” included in part of bit map 20. As noted above, the size of bit map 20 is the number of bits equal to the number obtained by subtracting 1 from the number of states. Thus, if the number of states is 10000, (Formula 3) requires an average 4999.5 times of addition.

Therefore, if the number of states is large, (Formula 3) is not practical in terms of calculation speed.

To solve this problem, bit map 20 and label table 21 are used together to greatly reduce the counted number of bits “1”.

Concretely, the index of transition destination table 22 is obtained by calculating a difference from the label closest in position to current state “s” and by performing addition or subtraction of the value of the label and the difference, rather than by accumulating all of the bits from the bit corresponding to state “0” of bit map 20 to the bit corresponding to the state “s−1” thereof.

First, the reference label is determined from current state “s”. The reference label is a label closest in position when viewed from s. It is assumed that the reference label is an (n+1)-th element of label table 21. It is to be noted that n=s÷B (any digits after the decimal point are ignored) is not easily established.

FIG. 12 is a view schematically showing a method for determining a reference label from current state “s”.

As shown in FIG. 12, if current state “s” belongs to the left half of a block, a label corresponding to the block is a reference label.

On the other hand, if current state “s” belongs to the right half of the block, a label corresponding to a block at the right side of the block is a reference label.

Thus, a formula for obtaining index “n” of label table 21 from current state “s” is as shown in (Formula 4).

$$n = ⌊ \frac{s + ⌊ \frac{B}{2} ⌋}{B} ⌋ \qquad [ Formula 4 ]$$

Next, a difference from the reference label is obtained from bit map 20.

If current state “s” belongs to the left half of the block, a numerical value obtained by adding a deficiency to LABEL(n) is the index of transition destination table 22. The deficiency is the number of bits having a value of 1 among all the bits starting from the bit at the farthest left end of the block to which state “s” belongs to the bit corresponding to state “s−1”. This deficiency is the aforementioned ‘difference’.

On the other hand, if the current state “s” belongs to the right half of the block, a numerical value obtained by subtracting a residue from LABEL(n) is the index of transition destination table 22. The residue is the number of bits having a value of 1 among all the bits starting from the bit at the farthest right end of the block to which state “s” belongs to the bit corresponding to state “s”. This residue is the aforementioned ‘difference’.

The above procedure of calculating the index of transition destination table 22 is expressed by a mathematical formula (Formula 5):

$$index ( s ) = \{ \begin{matrix}LABEL ( n ) - {\sum }_{t = s}^{nB - 1} BITMAP ( t ) & ( s < nB ) \\ LABEL ( n ) & ( s = nB ) \\ LABEL ( n ) + {\sum }_{t = nB}^{s - 1} BITMAP ( t ) & ( s > nB )\end{matrix} \qquad [ Formula 5 ]$$

By using of label table 21, the expected value of the number of times of addition in this step is reduced from ((number of states−1)÷2) times to (b÷4) times.

Afterwards, the contents of transition destination table 22 indicated by the index obtained in step 303 is substituted into s in step 304. Here, s is a transition destination, i.e., a next state.

For example, by taking transition destination table 22 shown in FIG. 9 as an example, if the index obtained in step 303 is 1, the next state is 9.

Thereafter, the routine returns to step 301.

As seen from above, according to the present invention, in a state transition diagram or state transition table for pattern matching, the amount of information of the state transition table is reduced by making use of the characteristic that if an input is identical, there occur many transitions from multiple states to the same state by comprising: rearranging the state transition table for every column unit so that the values of transition destinations of neighboring columns of the state transition table having a current state disposed in a column direction and an input symbol disposed in a row direction become the closest to each other, thus making it easier for the same value to be continuous in a horizontal direction; changing state names to arrange the current state of each column in ascending order; and creating, for every row, a bit map indicative of changing points of values and a transition destination table into which continuous values are integrated.

Furthermore, according to the present invention, it is possible to suppress lowering the state transition rate caused by reduction of the amount of information of the state transition table by employing a state transition method which creates a label in which the cumulative sum of bit values from the first bit to some bit of the bit map is recorded at predetermined intervals of the bit map, calculates the index of a transition destination table by obtaining a label closest in position to the current state and the difference from the label and performing addition or subtraction of the value of the label and of the difference rather than by obtaining the cumulative sum of bit values from the first bit to the bit corresponding to the current state in the bit map, and uses a transition destination indicated by the index as a next state when making a state transition by using the bit map and the transition destination table.

On the other hand, in the present invention, a program realizing the above-described function is recorded in a computer-readable recording medium, and the program recorded in this recording medium can be read out and executed by a computer. The computer-readable recording medium is a movable recording medium such as a floppy disk (registered trademark), a magneto optical disk, a DVD, a CD and additionally, a HDD or the like that is embedded in the computer. The program recorded in this recording medium is read out by a control unit (not shown) that the computer has, for example, and processed as described above by the control of the control unit.

While the present invention has been described with reference to the exemplary embodiment, the present invention is not limited to the exemplary embodiment. It will be understood by those skilled in the art that various changes can be made to the configurations or details of the present invention without departing from the scope of the invention.

This application claims priority based on Japanese Patent Application No. 2007-039209 filed on Feb. 20, 2007, the entire contents of which are incorporated herein by reference.

1. A pattern matching method using a finite automaton, comprising:
rearranging columns for every column unit so that the values of transition destinations of neighboring columns become closest to each other in accordance with a state transition table that has a current state arranged in a column direction and an input symbol arranged in a row direction and that shows the next state of transition destinations based on the current state and the input symbol;
changing state names to arrange the current state of each column in ascending order in the column rearranged state transition table; and
creating, for every row in the column rearranged state transition table, a bit map indicative of changing points of values of column transition destinations, and a transition destination table into which continuous same transition destinations are integrated.

2. The pattern matching method of claim 1, comprising:
dividing the bit map into blocks having a fixed length;
creating a label, for every block, indicative of the number of changing points existing between the leading block of the bit map and an arbitrary block;
selecting the label closest to the current state as a reference label and calculating a difference, which is the number of the changing points existing between a block corresponding to the reference label on the bit map and a bit corresponding to the state;
calculating the index of the transition destination table based on the number of changing points represented by the difference and the reference label; and
selecting a transition destination indicated by the calculated index as the next state.

3. A recording medium storing a program for implementing pattern matching using a finite automaton, which executes, by a computer:
rearranging columns for every column unit so that the values of transition destinations of neighboring columns become closest to each other in accordance with a state transition table that has a current state arranged in a column direction and an input symbol arranged in a row direction and that shows the next state of transition destinations based on the current state and the input symbol;
changing state names to arrange the current state of each column in ascending order in the column rearranged state transition table; and
creating, for every row in the column rearranged state transition table, a bit map indicative of changing points of values of column transition destinations, and a transition destination table into which continuous same transition destinations are integrated.

4. The recording medium of claim 3, storing a program for which executes, by a computer:
dividing the bit map into blocks having a fixed length;
creating a label, for every block, indicative of the number of changing points existing between the leading block of the bit map and an arbitrary block;
selecting the label closest to the current state as a reference label and calculating a difference, which is the number of the changing points existing between a block corresponding to the reference label on the bit map and a bit corresponding to the state;
calculating the index of the transition destination table based on the number of the changing points represented by the difference and the reference label; and
selecting a transition destination indicated by the calculated index as the next state.
